(19) United States
(12) Patent Application Publication
(10) Pub. No.: US 2012/0233817 A1
(43) Pub. Date: Sep. 20, 2012

(54) Window Shade with Enhanced Safety Features

(76) Inventors: Kai-Sheng Hsu, Yorba Linda, CA (US); Ramiro M. Ramirez, Las Vegas, NV (US); Chih Yung Wang, Taipei (TW)

(21) Appl. No.: 13/049,061

(22) Filed: Mar. 16, 2011

(51) Int. Cl. F16G 11/10

(52) U.S. Cl. 24/115 F

(57) ABSTRACT

Present invention teaches to build a Roman shade window curtain with enhanced child safety features built into the space between a front shade and a rear shade, where the “free play” of a lift cord is limited due to the “V” hole shape of a V-lock component and the outward pulling is also limited with the use of a safety connector generally place in between the mid vertical point of two rib pieces.

### FIELD OF THE INVENTION

The invention relates to the field of window coverings. More specifically, the invention is a system that will allow fabric and woven wood shades to be made in a manner that incorporate additional safety measures.

### BACKGROUND OF THE INVENTION

Window coverings are made for functional usages of blocking sunlight, or creating privacy, and for a decorative purpose. There are quite a number of styles and variations of window coverings which are commercially available. Traditional fabric curtains or drapes, plastic or wood mini-blinds, Roman shades, vertical blinds, etc, are all the commonly seen choices.

A traditional Roman shade can be made of fabric or woven wood material and typically consists of a head rail or track system, a lift system, which can be a semi-automatic spring loaded mechanism, a manual cord lift mechanism or even a remotely controlled motorized lift system. These lift systems all rely on the inherent cords that descend vertically through or from the head rail or track system to lift the shade. These shades will also contain several horizontal pleats, or folds, created at regular intervals along the vertical length of the shade. These exposed, cord-based systems present a danger to children, though consumers continue to desire the decorative nature of a Roman or Woven Wood shade.

FIGS. 1-a, 1-b and 1-c show a typical prior method of fabricating a roman shade. This roman shade has a decorative forward facing shade material extending from the head rail to the bottom rail with a plurality of cords passing through rings, loops or other cord connectors attached to the rear facing side of the decorative material. This shade can also comprise a blackout or dim out liner that is affixed to the rear of the forward facing decorative material where the liner has holes cut out so that the rings, loops or other cord connectors are exposed to the rear of the shade. In either embodiment of this prior method of fabricating a roman shade, the plurality of lift cords descend from the head rail and its lift mechanisms through the rings, loops or other cord connectors to be attached to the bottom rail. This method has been deemed unsafe by consumer safety groups in that the operating cords are exposed to the rear of the shade allowing a child to easily grab hold of the exposed cords and create a loop large enough to be considered dangerous as illustrated in FIG. 2.

FIGS. 3-a, 3-b and 3c shows another typical prior method of fabricating a roman shade. This roman shade has a decorative forward facing shade material extending from the head rail to the bottom rail with a plurality of cords passing through rings, loops or other cord connectors attached to the rear facing side of the fabric layer. This method incorporates a blackout or dim out liner that is affixed to the rear of the forward facing material, but unlike the construction shown in FIGS. 1-a through 1-c, the cords run through rings, loops or other cord connectors that are between the two distinct layers of material. This embodiment, while eliminating the exposed cords, still poses a safety concern in that a child could easily separate the two layers of material to access the operating cords and pull to generate a loop as shown in FIG. 4.

FIGS. 5-a and 5-b show yet another prior method of fabricating a roman shade. This roman shade has a decorative forward facing shade material extending from the head rail to the bottom rail with a plurality of cords passing through rings, loops or other cord connectors attached to the rear facing side of the fabric layer. This method also incorporates a blackout or dim out liner that is completely affixed to the forward facing decorative material by sewing the outer left and right edges of both materials together, in effect creating a sewn pocket in which the operating cords are inaccessible. Although this method addresses the safety concern, it creates an unsightly shade when in the raised position. When the two layers of material are sewn in this fashion, the individual pleats are not allowed to create the desired fold or hobble affect. This method bunches upwards in a fashion similar to that shown in FIGS. 6-a and 6-b.

### SUMMARY OF THE INVENTION

It is an objective of this invention to provide a winder shade that is aesthetically pleasing, functional and cost effective while incorporating multiple unique safety features.

It is yet another objective of this invention to provide a winder shade that by design reduces if not eliminates the likelihood of the operating cords from being pulled outwards from the shade and becoming a safety hazard.

It is yet another objective of this invention to provide the window coverings industry with a shade system that is simple to fabricate and cost effective as it is designed to operate ideally with the current proven low-cost cord lift systems.

It is yet another objective of this invention to create a shade system that allows for the fabricator to continue to provide the consumer with roman shades using the multitude of woven fabrics, non-woven fabrics, woven woods and films available to suit their individual preferences.

Additional objectives and advantages of the present invention will become apparent to those skilled in the art from a description of certain present preferred embodiments thereof shown in the drawings which follow.

### DESCRIPTION OF THE DRAWINGS

The accompanying drawings, which are incorporated in and constitute a part of this specification, illustrate prior methods and the preferred embodiments of the invention and together with the description, serve to explain the principles of the invention.

A brief description of the drawings is as follows:

FIGS. 1-a, 1-b and 1-c show a typical prior method of fabricating a roman shade with or without a liner. This method has exposed cords to the rear of the shade.

FIG. 2 shows the same prior method as FIGS. 1-a through 1-c, but illustrates the potential safety hazard when the exposed cord is pulled to generate a loop.

FIGS. 3-a, 3-b and 3-c show another prior method of fabricating a roman shade with a liner. This method has cords which descend vertically between the layers of material.

FIG. 4 shows the same prior method as FIGS. 3-a, 3-b and 3-c but illustrates how the two layers of fabric can be easily separated to access the operating cords to create the potentially hazardous loop.

FIGS. 5-a and 5-b show yet another prior method in which the two layers of material are sewn on the left and right edges generating an envelope effect. This method encases the operating cords.

FIGS. 6-a and 6-b show the same prior method as FIGS. 5-a and 5-b, but show the unsightly affect that this method creates in the raised position. The individual pleats bunch up as opposed to creating the typically roman shade hobble or fold.

FIG. 7 shows the overall 2-cord system (lift cord and connect cord) of present invention with the front and rear shades removed front sight.

FIG. 8 shows the V-lock component and how it will be installed to a rib piece, having the corresponding downward protrusions matching to the holes on the rib piece.

FIG. 9 illustrates the “pocket” created in present invention.

FIG. 10 shows the “C” opening on the rib piece.

FIG. 11 shows the ball-ring structure.

FIG. 12 shows the side view, partially, of a completed window shade where the front and back fabrics are secured to the rib pieces using the ball-ring structures.

FIG. 13 shows another illustration of the “pocket” when the rib piece with “C” openings are in place.

FIG. 14 shows the placement of the safety connector and the limited outward tugging that may happen if pulled by a child.

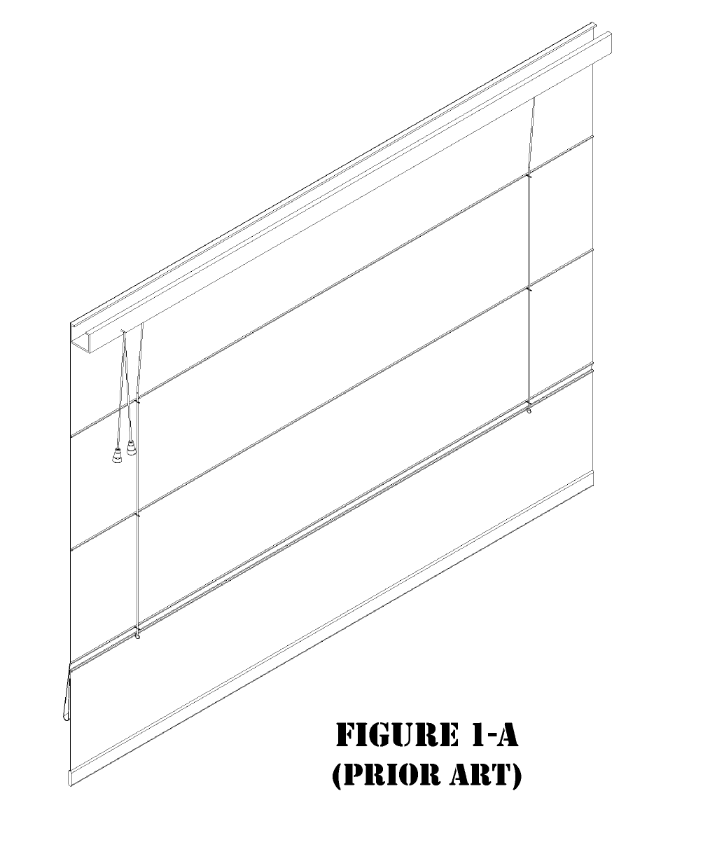

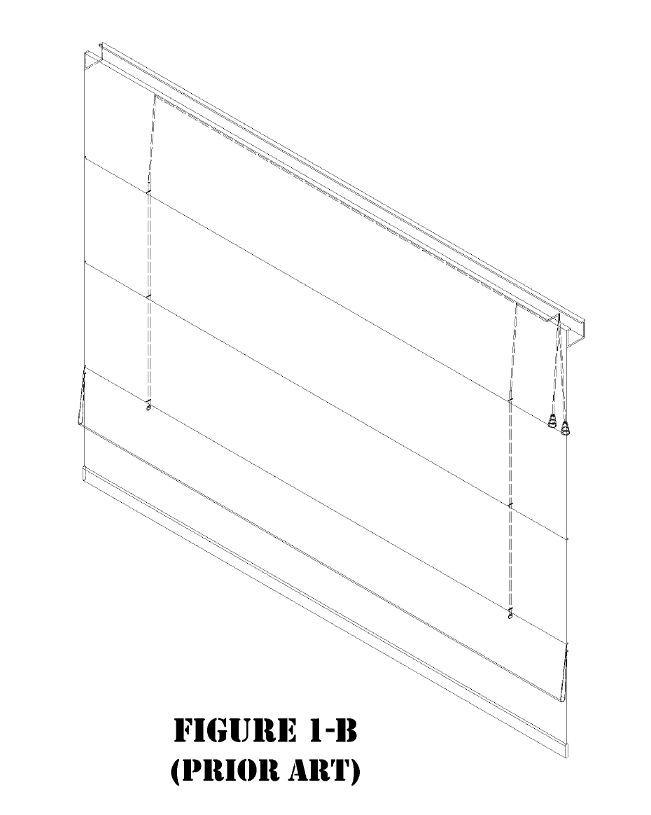

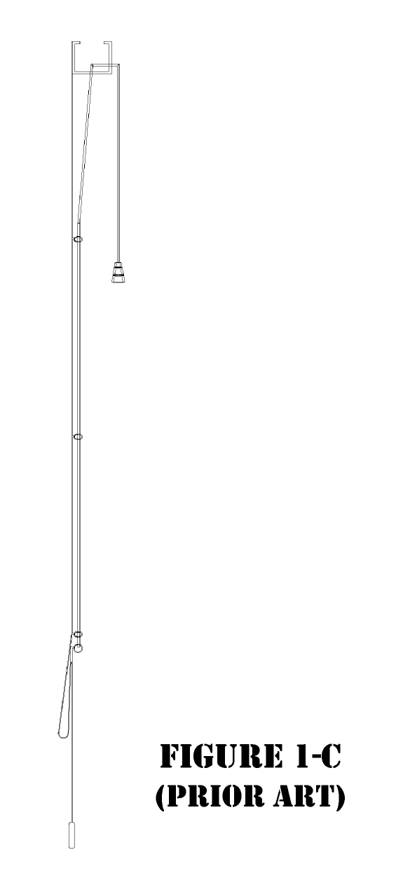

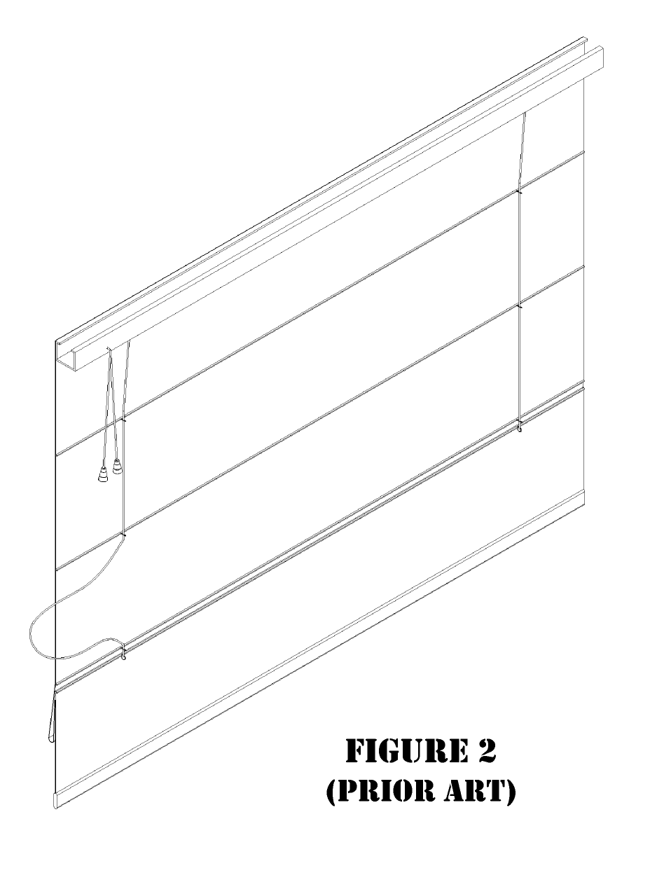

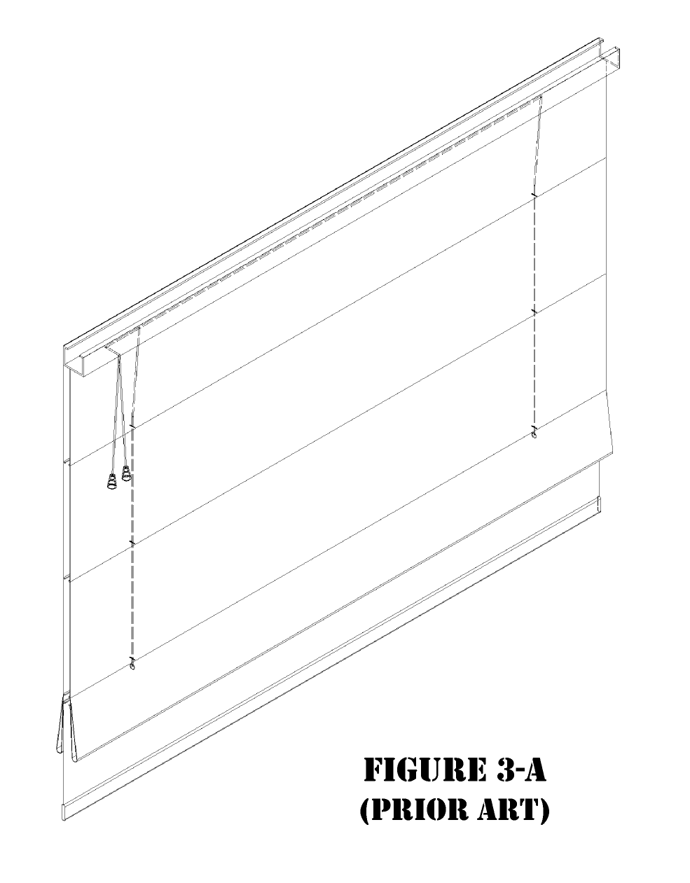

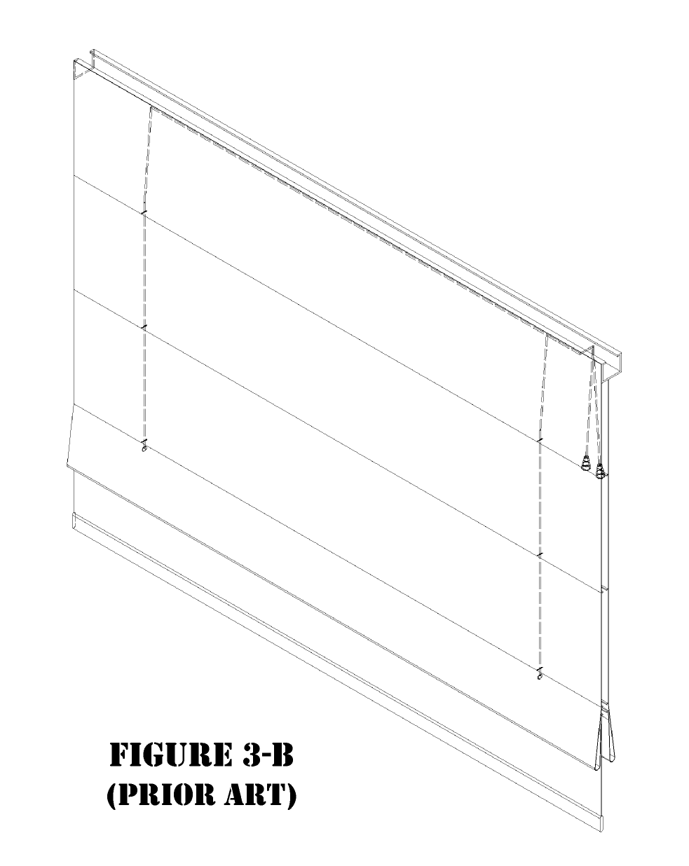

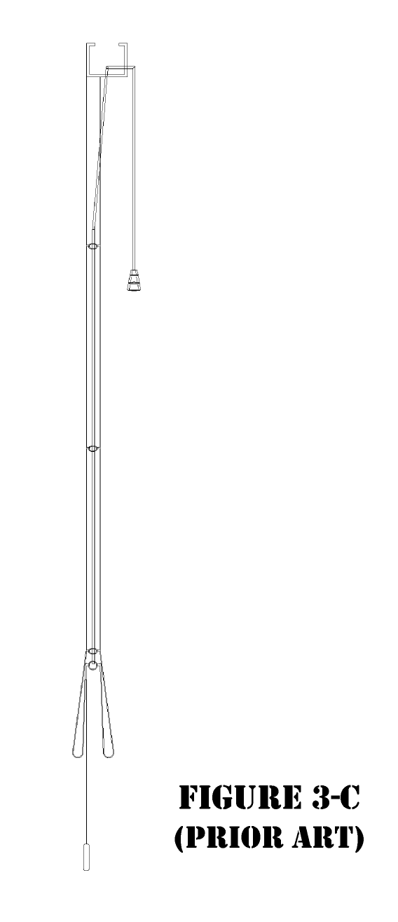

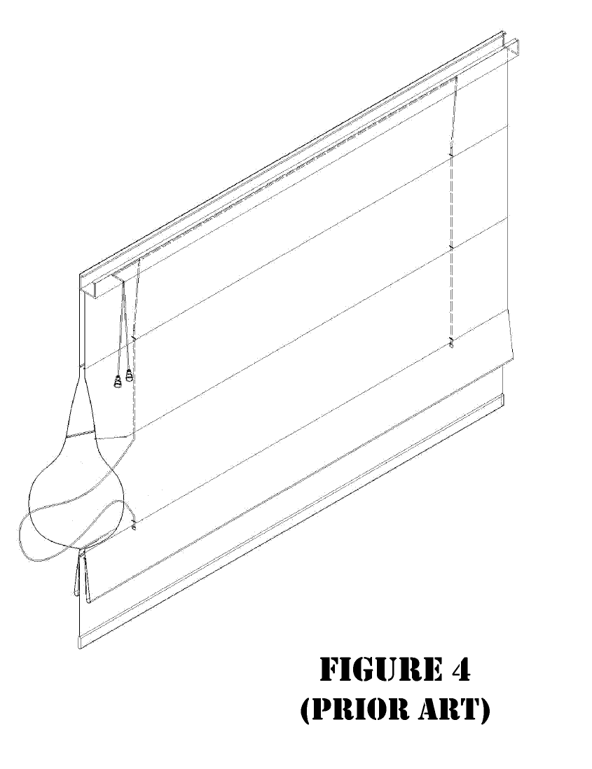

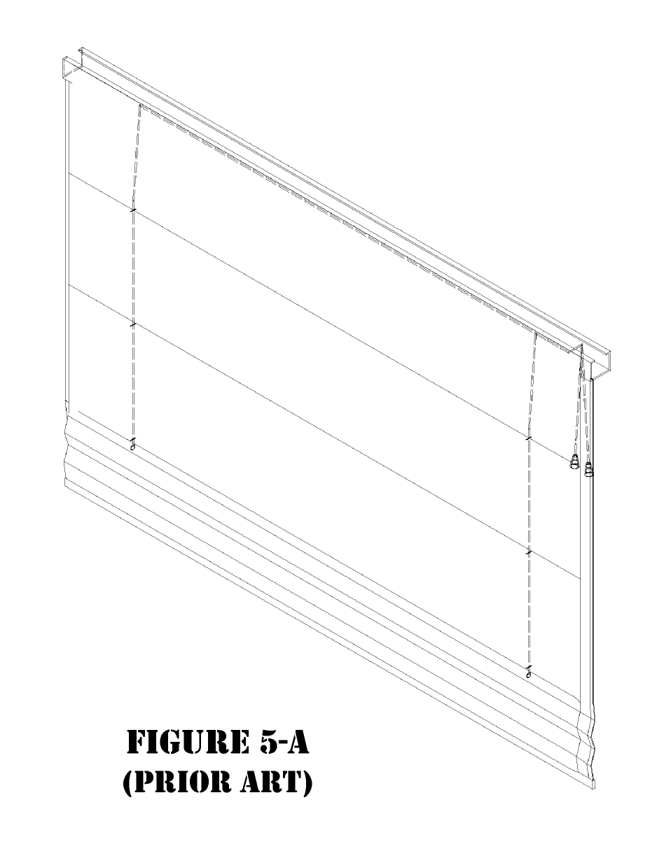

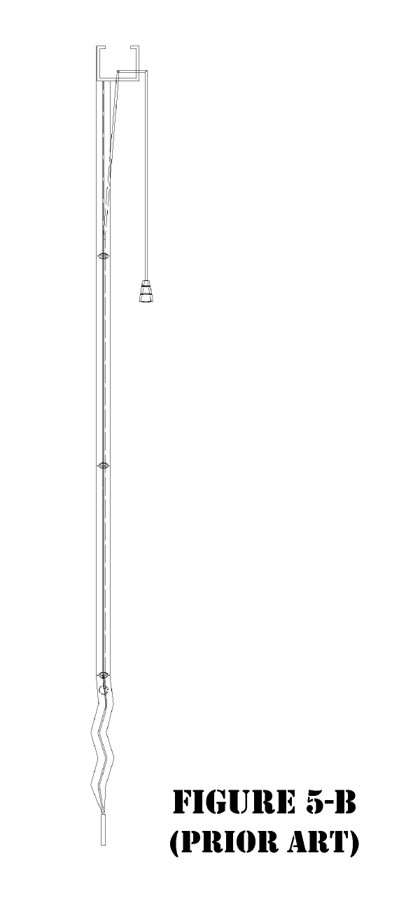

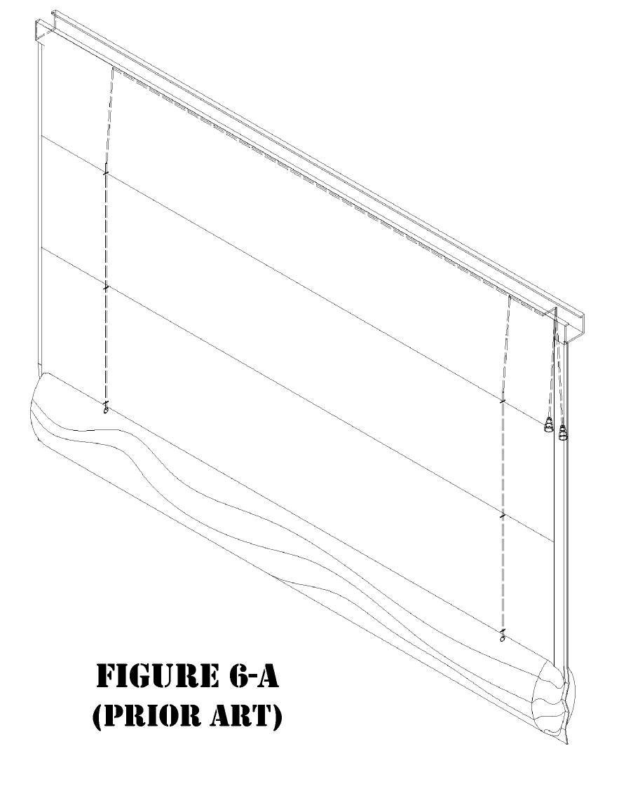

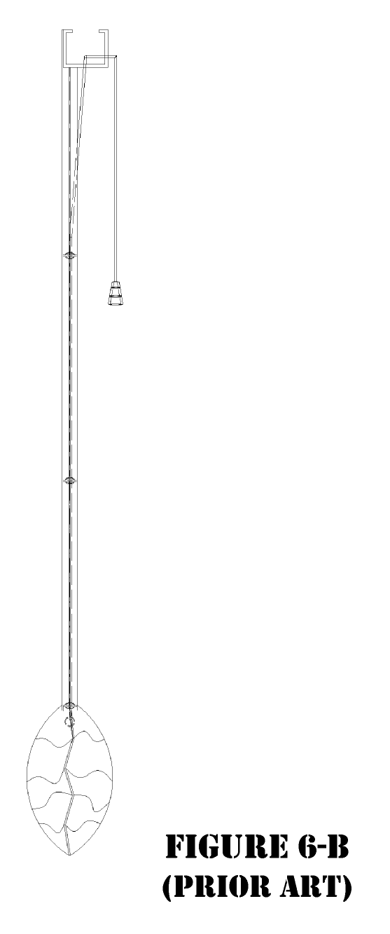

### DETAILED DESCRIPTION OF THE PREFERRED EMBODIMENT

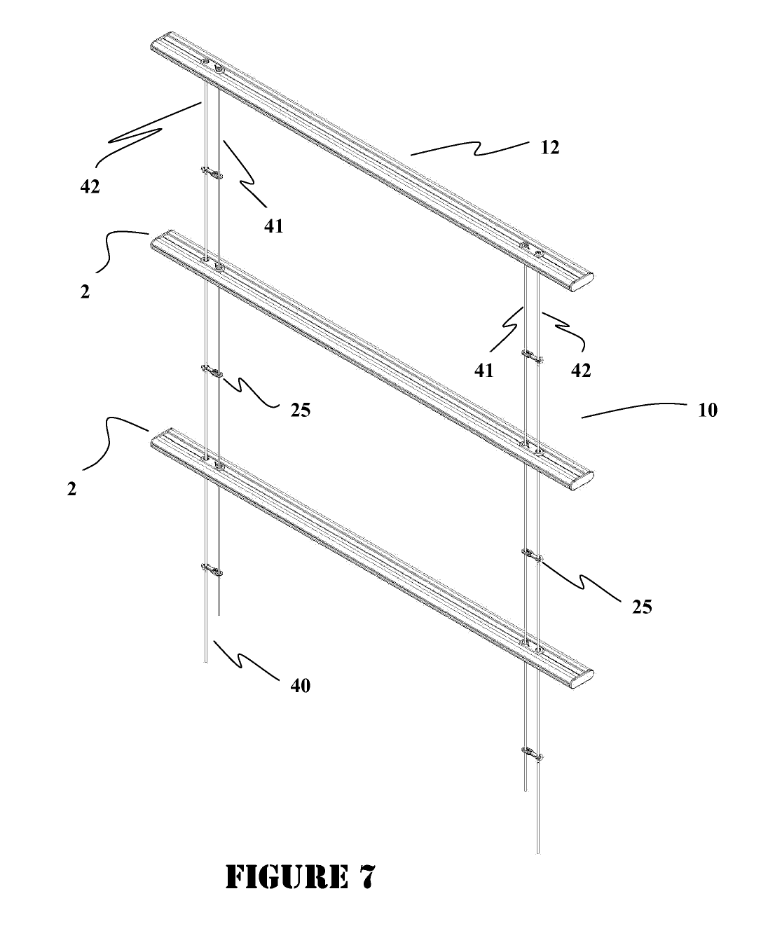

As shown in FIG. 7, present invention teaches a Roman shade 10 cord-locking safety mechanism where a plurality of rib pieces 2 are used to serve as the horizontal division, creating the wavy and segmented folds on a Roman shade desired by consumers.

A two-cord lift/connect system 40 is built to the left side and right side of the Roman shade 10, wherein one of the two cords is a lift cord 41 and the other one of the two cords is a connector cord 42.

The top of said Roman shade is a head rail 12 which forms the first horizontal piece from where the front fabric 51 shade drapes down and the two-cord system 40 also extend down from said head rail 12 on the two sides of said Roman shade.

In actual implementation of present invention, said head rail 12 can use the same rib piece 2 as those the form the folds below.

On the left and right side along the horizontal length of each of said rib pieces 2, there are two adjacent holes 61 and 62, allowing the lift cord 41 and connector cord 42 to thread through vertically. The two adjacent holes are made along the length-wise direction of the rib pieces 2.

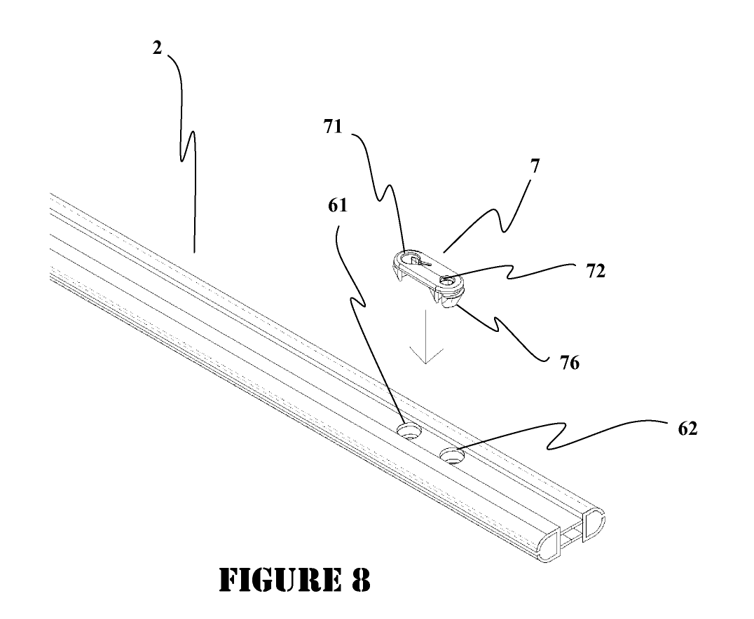

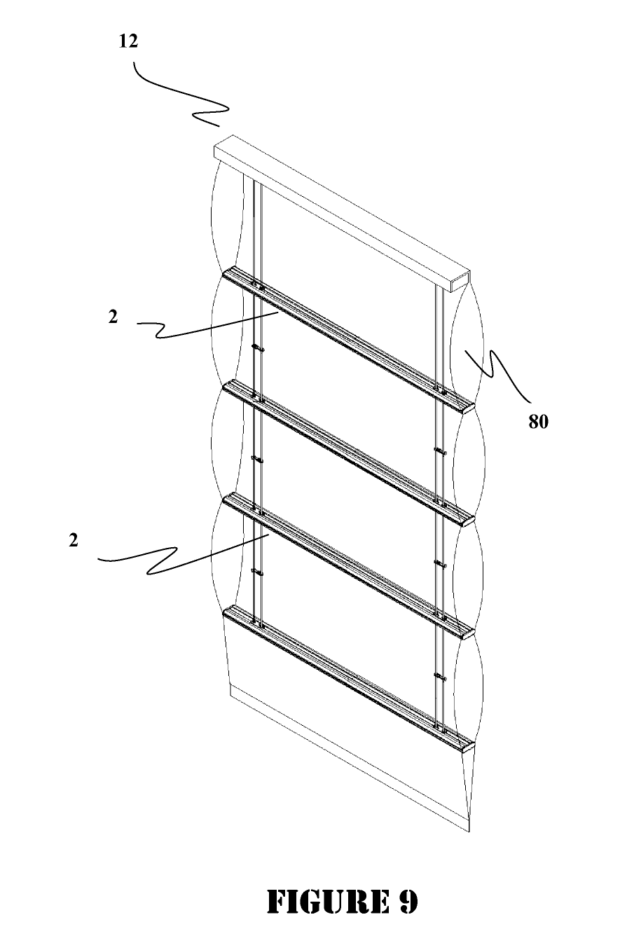

FIG. 8 shows the V-lock component 7 and indication of the direction of V-lock component to holes 61/62 on said rib piece 2.

A V-lock component 7 is made to have two holes, with a bigger hole 71 made to have a tapered V shape pointing towards the other smaller hole 72, which is generally round shape. At time of installation, the smaller hole 72 on the V-lock component 7 will be fitted to the outside hole 62 of the two adjacent holes near the outside edge of said rib piece 2, while the V-shaped hole 71 of the V-lock component 7 will be fitted to the other bigger hole 61 of the two-adjacent holes, which will be closer to the horizontal mid-point of the rib piece 2.

A short length of protruding lip 76 is made from one side (treated as bottom side) of each of the two holes 71/72 on the V-lock component 7, so that the protruding lip 76 will be matching to the diameter of the two adjacent holes 61/62 on the rib pieces 2 when said V-lock component 7 is installed to the rib piece 2.

The lift cord 41 is threaded through the V hole 71 of the V-lock component 7 and the corresponding bigger hole 61 on the rib piece 2.

The connector cord 42 is threaded through the smaller hole 72 on the V-lock component 7 and the corresponding (smaller) hole 62 on the rib piece 2.

In actual products and models, the protruding lips 76 from the V-hole 71 and the smaller hole 72 of the V-lock component 7 will easily guide the correct installation as the protruding lips 76 are sized to match the two adjacent holes 61/62 on the rib piece 2.

In between every two rib pieces 2, a safety connector 25 is fixed roughly to the mid-point along the vertical length of the fold created by the rib pieces 2, where the lift cord 41 and the connector cord 42 are fixed onto said safety connector 25. Said safety connector 25 limits the amount of lateral tugging and free play of the lift cord 41, due to the structure of the V-hole 71 on the V-component 7, as explained below.

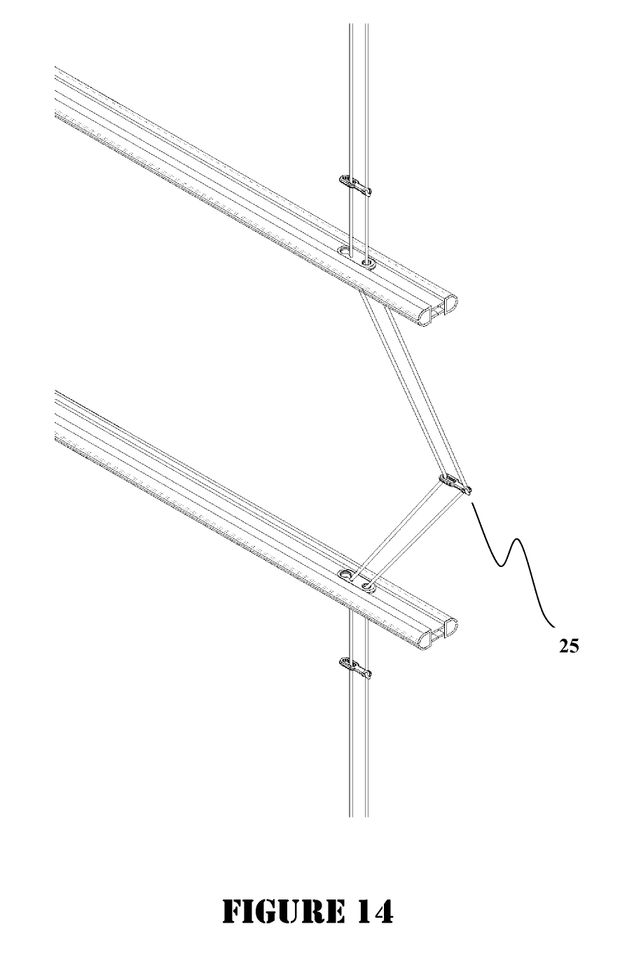

FIG. 14 shows the position of said safety connect 25 and the limited outward “tugging” that may happen if pulled by a child. Even in the case where the two cords (41 and 42) are pulled out by a child, the amount of the rounded loop between the two cords are limited (roughly cut to half of the loop size) due to the existence of safety connector 25.

When fully installed and operational, a Roman shade 10 of present invention will stop the free tugging and pulling out of the lift cord 41, due to the fact that the V-hole 71 is pointing towards the outside of the rib piece 2 and when the lift cord 41 is being pulled outward, the tapered end of the V-hole 71 will catch the lift cord 41, preventing it from any further free-play or tugging away and creates a safety feature that does not allow tangling of a child's head to the lift cord 41.

An alternative implementation of the safety feature is for said additional V-lock component 7 to combine to said safety connector 25. Said safety connector 25 is made to have two holes matching the two protruding lip 76 of the V-lock 7, so that that lift cord 41 and connect cord 42 go through the holes on the V-lock 7 and the two holes on the safety connector 25, where V-lock 7 is attached to the top of safety connector 25.

A further safety feature of the Roman shade 10 is a pocket-controlling safety mechanism. This “pocket” 80 refers to the opening on the side formed by the front fabric 51 and back fabric 52 and in between an upper rib piece 2 and a lower rib piece 2.

Refer to FIG. 8 for illustration of this “pocket” 80.

For the “pocket” 80 on the very top, the upper rib piece 2 would be the headrail 12; however, the structure and operation for the mechanism of each pocket 80 will be the same whether the upper rib piece 2 is the head rail 12 or other rib pieces 2 horizontally placed to create the folds of the wavy pattern on a Roman shade 10.

A plurality of rib pieces 2, serving as the segmented horizontal division for the folds on a Roman shade 10, are made to contain a “C” opening 3 on the forward-facing and rear-facing sides, for receiving fabric material either directly or by a ball ring structure 8 that can press or squeeze some portion of the front fabric 51 into the “C” opening 3.

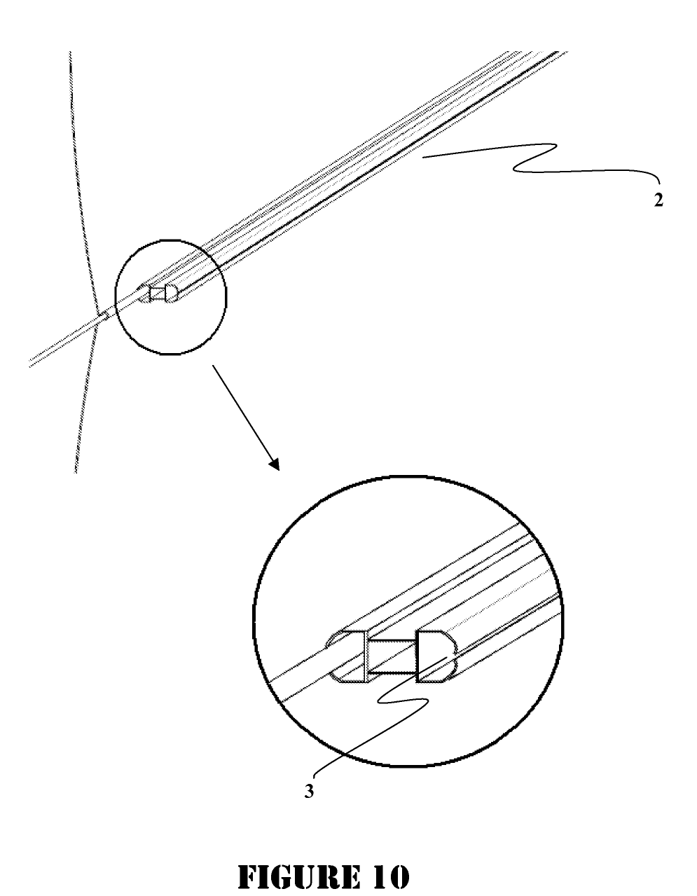

The rib piece 2 with the “C” opening is shown on FIG. 10, where a partial magnified view of the opening is shown.

From the side, a “pocket” 80 will form between a front layer fabric 51 and a back layer fabric 52 draping down from a head rail 12 and as segmented by an upper rib piece 2 and lower rib piece 2. So, each “fold” on the Roman shade is a “pocket” 10 when looking at it from the side.

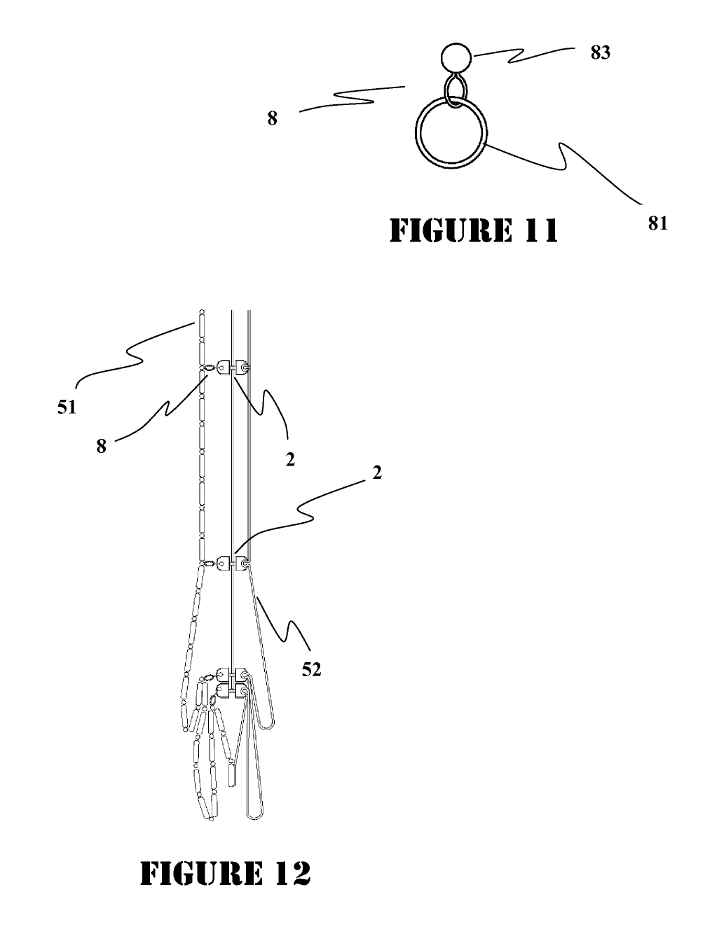

A plurality of ball-ring structure 8, as shown in FIG. 11, will be used to secure the front fabric 51 to the rib piece 2. The size of the ball portion 83 is made to correspond to the inner size of the “C” opening 3 on the rib piece 2, so that the ball-ring structure 8 can be fitted to the rib piece 2 by placing the ball portion 83 into the “C” opening 3 of the rib piece 2.

FIG. 12 illustrates the use of the ball-ring structure 8 to connect the front fabric 51 (which may be normal cloth-based fabric, or a wood-strip type shade) to the rib piece 2. The rear fabric 52 is also shown on FIG. 12.

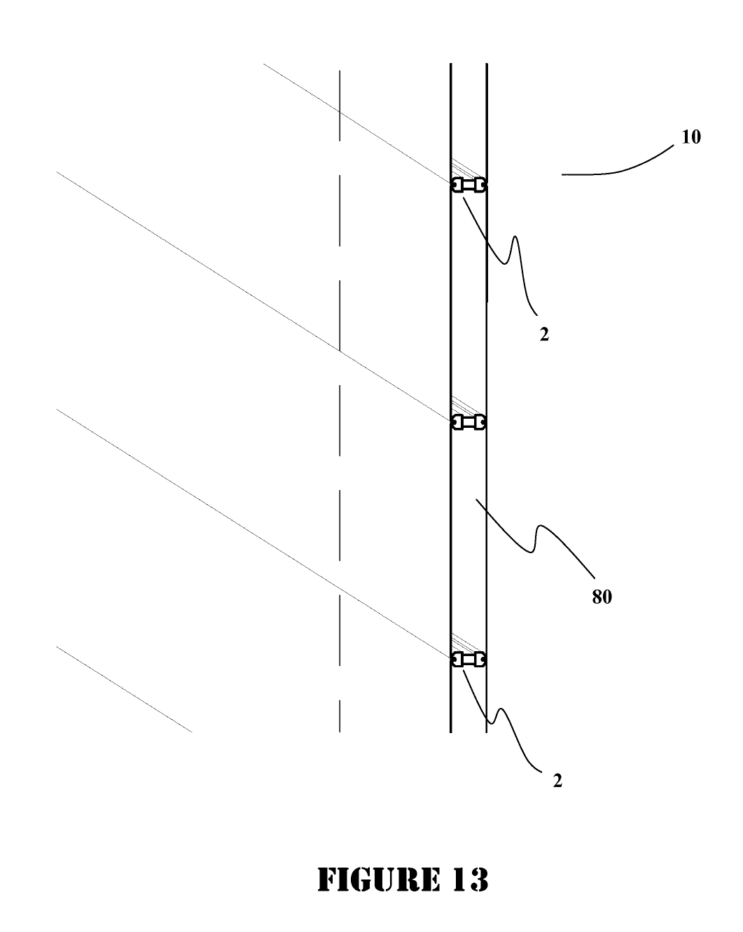

FIG. 13 also shows the “pocket” 80 created by the two-layer fabrics.

The ring portion 81 of the ball-ring structure 8 will then be attached or sewn to the front fabric 51.

The use of the ball-ring structure 8 allows the formation of the “folds” on the front fabric 51 to appear more flowing and creates a desirable wavy pattern.

The lift cord 41 and the connector cord 42, or any lifting mechanism for the Roman shade 10 will be placed inside the two layers of the fabric and is thus not easily reached by children.

The illustration and explanation in the present application for the lifting mechanism as detailed herein can be both manual and any motorized system, as the teaching in this regard is not limited to either implementation.

The “pocket” 10 on the side will have limited size and is not sufficient for a human head to go into the pocket 10, thus promoting the safety standards on a Roman shade pursuant to the teaching herein.

1. A Roman shade cord-locking safety mechanism comprising:
a. A plurality of rib pieces serving as the segmented horizontal division for the folds on a Roman shade;
b. A two-cord construction on the left and right ends of said Roman shade wherein one of the two cords is a connector cord and the other one of the two cords is a lift cord, wherein the two cords on each end of said Roman shade extend down from a head rail through said rib pieces and to the lowest rib piece on said Roman shade; and,
c. A V-lock component is installed on the left and right ends of each of said rib piece for the two cords to string through and a safety-connector is positioned at a vertical mid-point between an upper and an lower rib piece, wherein the lift cord goes through a V hole on each of the V-lock component and the connector cord goes through the other smaller hole on the V-lock component.

2. The safety mechanism of claim 1, wherein the V-lock component is installed in a way that the V hole situates towards the inner portion of the rib it is attaching and the other smaller hole situates towards the outer portion of each of the rib and the narrow portion of the V hole is pointing towards the outer side of each of the rib.

3. The safety mechanism of claim 2, wherein two holes on the left and right ends of each of the rib are made and configured to fit the V-lock component, so as to receive matching lip protrusions from the V-lock.

4. The safety mechanism of claim 3, wherein said safety connector is made to have two holes matching the two protruding lips of the V-lock, resulting in V-lock component installed to the top of said safety connector and the lift cord 41 and connect cord 42 going through the holes on the combination of V-lock and the safety connector.

5. A Roman shade pocket-controlling safety mechanism, comprising:
a. A plurality of rib pieces serving as the segmented horizontal division for the folds on a Roman shade, wherein each of said rib contains a “C” opening on the forward-facing and rear-facing sides, for receiving fabric material either directly or by a ball ring structure that can crimp fabric into the “C” opening;
b. A front layer fabric and a back layer fabric suitable for draping down from a head rail and are attached to each of said horizontal rib pieces, forming the needed folds; and,
c. A plurality of ball-ring components wherein the size of the ball is corresponding to the inner size of the “C” opening on the rib, allowing the ring portion to be attached or sewn to the front fabric, whereby a pocket of a controlled size is formed between the front fabric and the rear fabric in between any of two horizontal ribs, so that there is no sufficient space to allow a human head to go into the pocket formed between front and rear fabric in between any two ribs.

6. The Roman shade safety mechanism of claim 5 wherein said horizontal rib pieces contain holes to allow lifting mechanism to thread through, from the headrail on the top to the lowest rib piece at the bottom and the lifting mechanism is placed in between the two fabric layers.

7. The Roman shade safety mechanism of claim 6, wherein said lifting mechanism is one or more cords that can be actuated by manual force or motorized means.
